(19) United States
(12) Patent Application Publication
(10) Pub. No.: US 2025/0169537 A1
(43) Pub. Date: May 29, 2025

(54) AEROSOL PROVISION DEVICE COMPRISING A HEAT CONDUCTING LINING

(71) Applicant: NICOVENTURES TRADING LIMITED, London (GB)

(72) Inventor: Michael THOMAS, London (GB)

(21) Appl. No.: 18/842,517

(22) PCT Filed: Mar. 1, 2023
(86) PCT No.: PCT/EP2023/055233

§ 371 Date: Aug. 29, 2024

(30) Foreign Application Priority Data
Mar. 2, 2022 (GB) 2202870.8

(51) Int. Cl. A24F 40/46; A24F 40/42; H05B 3/22

(52) U.S. Cl. CPC A24F 40/46; A24F 40/42; H05B 3/22

(57) ABSTRACT

An aerosol provision device including a main housing and a heating element, wherein the main housing has a base portion and the heating element projects from the base portion. The aerosol provision device includes a first outer casing surrounding at least a portion of the main housing; and a graphite liner. The graphite liner is arranged so as to be in thermal contact with the base portion of the main housing and also with the first outer casing in order to conduct heat energy away from the base portion to the first outer casing.

### RELATED APPLICATIONS

The present application is a National Phase entry of PCT Application No. PCT/EP2023/055233 filed Mar. 1, 2023, which claims priority to GB Application No. 2202870.8 filed Mar. 2, 2022, each of which is hereby incorporated by reference in their entirety.

### TECHNICAL FIELD

The present invention relates to an aerosol provision device, an aerosol generating system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

Conventional aerosol provision devices comprise a cylindrical heating chamber into which a rod shaped consumable is inserted.

It is desired to provide an improved aerosol provision device.

### SUMMARY

According to an aspect there is provided an aerosol provision device comprising:
a main housing having a base portion;
a heating element which projects from the base portion of the main housing;
a first outer casing surrounding at least a portion of the main housing; and
a graphite liner, wherein the graphite liner is arranged so as to be in thermal contact with the base portion of the main housing and also with the first outer casing in order to conduct heat energy away from the base portion to the first outer casing.

According to various embodiments an aerosol provision device is disclosed having a heating element. A receptacle for receiving an aerosol generating article may also be provided which may surround the heating element. The receptacle may be part of a removable cap which may be magnetically retained to the main housing of the aerosol provision device.

Due to the construction of an aerosol provision device according to various embodiments having a removable cap including a receptacle for receiving a consumable, heat energy may be transferred from the heating element into the receptacle and hence into the removable cap which is undesirable.

In order to address undesirable heating of the removable cap, the aerosol provision device comprises a graphite liner which may be arranged so as to make physical and thermal contact with the main housing of the aerosol provision device particularly in proximity to the location of the heating element. As a result, the graphite liner is effective in diverting heat energy which would otherwise be transmitted into the receptacle and hence into removable cap. Instead, the graphite liner is arranged to dissipate the heat energy into an outer casing which may surround a majority of the main housing of the aerosol provision device. For example, the graphite liner may extend along the length of the main housing of the aerosol provision device including an intermediate section (which may include an electronics module) and a distal section (which may include a battery module). As a result, heat energy can be dissipated over a relatively large surface area and the temperature of the removable cap can be prevented from becoming unduly warm.

It will be appreciated, therefore, that the provision of a graphite liner in an aerosol provision device having a removable cap is particularly beneficial in terms of reducing the temperature of the removable cap in use.

Further embodiments are contemplated wherein the graphite liner may, more generally, comprise a carbon material. For example, embodiments are also contemplated wherein the liner comprises graphene or a material comprising carbon nanotubes.

Optionally, the base portion of the main housing may comprise polyetheretherketone (“PEEK”). However, other embodiments are contemplated wherein the base portion of the main housing may be made from other materials including other plastics materials.

Optionally, the first outer casing comprises a first metal.

Optionally, the first metal comprises aluminum. However, other embodiments are contemplated wherein the first metal may comprise other metals.

Optionally, the heating element comprises a resistive heating element.

Optionally, the main housing further comprises a tubular element.

Optionally, the aerosol provision device further comprises a removable cap which in use is retained to the tubular element. According to various embodiments the removable cap may be magnetically retained to the tubular element.

Optionally, the removable cap may comprise a receptacle which at least partially surrounds the heating element. The receptacle may function in order to assist in the removal of a spent aerosol generating article from the heating element at the end of a session of use.

Optionally, the receptacle comprises polyetheretherketone (“PEEK”). However, other embodiments are contemplated wherein the receptacle comprises other materials including other plastics materials.

Optionally, the receptacle may comprise a tubular portion and a base portion. The base portion of the receptacle may comprise an aperture.

Optionally, the heating element projects, in use, through the aperture provided in the base portion of the receptacle.

Optionally, the removable cap further comprises a second outer casing.

Optionally, the second outer casing surrounds, in use, the tubular element of the main housing.

Optionally, the second outer casing comprises a second metal.

Optionally, the second metal comprises aluminum. However, other embodiments are contemplated wherein the second metal may comprise other metals.

According to another aspect there is provided an aerosol generating system comprising:
an aerosol provision device as described above; and
an aerosol generating article.

According to another aspect there is provided a method of generating an aerosol comprising:
providing an aerosol provision device as described above; and
inserting an aerosol generating article into the aerosol provision device.

According to another aspect, there is provided an aerosol provision device comprising:
a main housing having a base portion;
a heating element joined to the main housing;
a first outer casing surrounding at least a portion of the main housing; and
a graphite liner, wherein the graphite liner is arranged so as to be in thermal contact with the base portion of the main housing and also with the first outer casing in order to conduct heat energy away from the base portion to the first outer casing.

Optionally, the base portion of the main housing may comprise polyetheretherketone (“PEEK”). However, other embodiments are contemplated wherein the base portion of the main housing may be made from other materials including other plastics materials.

Optionally, the first outer casing comprises a first metal.

Optionally, the first metal comprises aluminum. However, other embodiments are contemplated wherein the first metal may comprise other metals.

Optionally, the heating element comprises a resistive heating element. Optionally, the heating element is tubular.

Optionally, the main housing further comprises a tubular element.

Optionally, the aerosol provision device further comprises a removable cap which in use is retained to the tubular element. According to various embodiments the removable cap may be magnetically retained to the tubular element.

Optionally, the removable cap may comprise a receptacle. The receptacle may be at least partially received in the heating element. The receptacle may function in order to assist in the removal of a spent aerosol generating article from the heating element at the end of a session of use.

Optionally, the receptacle comprises polyetheretherketone (“PEEK”). However, other embodiments are contemplated wherein the receptacle comprises other materials including other plastics materials.

Optionally, the receptacle may comprise a tubular portion and a base portion.

Optionally, the removable cap further comprises a second outer casing.

Optionally, the second outer casing surrounds, in use, the tubular element of the main housing.

Optionally, the second outer casing comprises a second metal.

Optionally, the second metal comprises aluminum. However, other embodiments are contemplated wherein the second metal may comprise other metals.

### BRIEF DESCRIPTION OF THE DRAWINGS

Various embodiments will now be described by way of example only and with reference to the accompanying drawings in which:

FIG. 1 shows an aerosol provision device located within a charging unit according to an embodiment;

FIG. 2 shows a cross-sectional view of an aerosol provision device located within a charging unit;

FIG. 3 shows in greater detail a graphite liner arranged to be in thermal contact with the housing surrounding a heating element according to an embodiment in order to divert heat energy away from a consumable cartridge which surrounds the heating element and wherein the consumable cartridge is attached to the inside of a removable cap which is retained to the main housing of the aerosol provision device;

FIG. 4 shows in greater detail a graphite liner which makes physical and thermal contact with a base portion of the main housing in the vicinity of a heating element and which is arranged to divert heat energy away from a removable cap and instead to dissipate the heat energy into a metal outer liner surrounding the main housing of the aerosol provision device;

FIG. 5 shows the whole of an aerosol provision device according to an embodiment and shows a graphite liner which extends along the majority of the length of the main housing of the aerosol provision device; and

FIG. 6 shows another view of the graphite liner which is provided according to an embodiment and which makes thermal contact with a housing in the vicinity of the heating element and also with an outer casing of the main housing of the aerosol provision device.

### DETAILED DESCRIPTION

Aspects and features of certain examples and embodiments are discussed or described herein. Some aspects and features of certain examples and embodiments may be implemented conventionally and these are not discussed or described in detail in the interests of brevity. It will thus be appreciated that aspects and features of apparatus and methods discussed herein which are not described in detail may be implemented in accordance with conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

For completeness, aerosol provision devices comprising an inductive element are known. The aerosol provision device may comprise one or more inductors and a susceptor which is arranged to be heated by the one or more inductors.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Various embodiments will now be described in more detail.

According to various embodiments an aerosol provision device is provided which may be arranged to be chargeable by a charging unit. The interaction of the aerosol provision device with a charging unit is described below for illustrative purposes only.

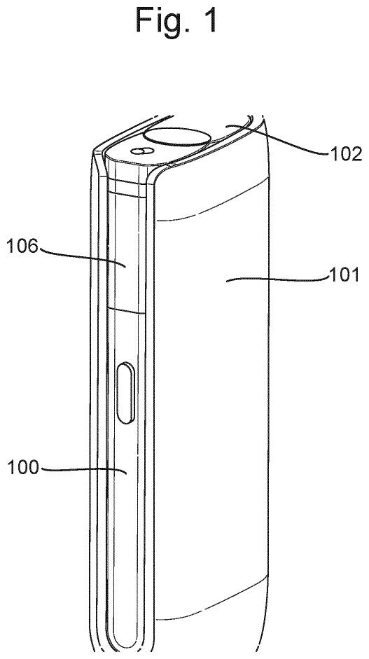

FIG. 1 shows an aerosol provision device 100 according to an embodiment shown located within an elongate cavity of a charging unit 101. The charging unit 101 may comprise a power source (not shown). The power source may include, for example, a battery (single-use or rechargeable), a rechargeable super capacitor, a rechargeable solid-state battery (SSB), a rechargeable lithium-ion battery (LiB) or the like, a hermetically sealed battery, a pouch cell battery or some combination thereof. Whilst the aerosol provision device 100 is shown in combination with a charging unit 101, it will be appreciated that the aerosol provision device 100 may be provided with power by any other means. For example, a power source provided with aerosol provision device 100 may be charged by plugging a power supply into the aerosol provision device 100, or the power source may be replaceable, e.g. in the form of a replaceable battery.

The aerosol provision device 100 may be left in the charging unit 101 for a predetermined time in order to allow sufficient charging of the aerosol provision device 100. For example, the charging unit 101 may be arranged to charge the aerosol provision device 100 to full charge in a time of <10 mins, 10-20 mins, 20-30 mins, 30-40 mins, 40-50 mins, 50-60 mins or >60 mins.

The charging unit 101 and/or the aerosol provision device 100 may optionally have an indicator to give a visual or other representation to the user of the charging level of the aerosol provision device 100. Additionally, there may be a separate indicator to give a visual representation of the charge level of the charging unit 101. The current charge level of the aerosol provision device 100 and/or the charging unit 101 may be determined by control means disposed in the aerosol provision device 100 and/or the charging unit 101.

The visual indicator may comprise one or more light-emitting diodes (LEDs). However, other embodiments are contemplated where the visual indicator may be replaced by an audio indicator (e.g. a speaker) or a haptic indicator.

The aerosol provision device 100 may comprise an outer housing which may have a tubular and/or cylindrical shape. However, other embodiments are envisaged wherein the aerosol provision device 100 may take other desired forms e.g. the aerosol provision device 100 may be boxed shaped. According to an embodiment the outer housing of the aerosol provision device 100 may comprise an electrical insulator and may, for example, be formed of polyetheretherketone (“PEEK”).

According to an embodiment the distal end of the aerosol provision device 100 may comprise one or more orientation features and/or one or more magnets for securing the distal end of the aerosol provision device 100 to a base portion of the charging unit 101.

The aerosol provision device 100 may be inserted into the cavity of the charging unit 101 in order to recharge the aerosol provision device 100 by receiving electrical power from the charging unit 101. The charging unit 101 may comprise an internal battery to provide electrical power to the aerosol provision device 100. The charging unit 101 may also be connected to an external source of electrical power.

The charging unit 101 may comprise a lid or cover 102 which may be slid by a user between an open and closed position. The lid or cover 102 is provided at the entrance to the cavity which is provided within the charging unit 101 and which is configured to receive the aerosol provision device 100.

The aerosol provision device 100 includes an aerosol generator for generating aerosol from aerosol generating material. According to an embodiment the aerosol provision device 100 comprises a resistive heater for heating an aerosol generating article.

When the lid or cover 102 is in the open position an opening to the cavity is exposed thereby enabling a user to either remove the aerosol provision device 100 from the charging unit 101 (in order to use the aerosol provision device 100) or alternatively to insert the aerosol provision device 100 into the charging unit 101 (in order to charge the aerosol provision device 100).

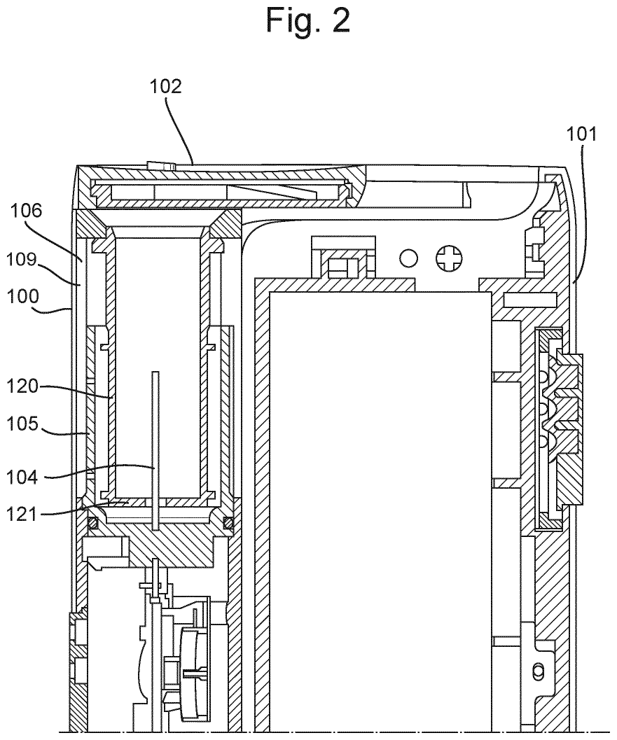

FIG. 2 shows a cross-sectional view showing the aerosol provision device 100 located or docked within the charging unit 101. The aerosol provision device 100 comprises a main housing 105 wherein a resistive heating element 104 projects within the main housing 105. The aerosol provision device 100 further comprises a removable cap 106 which may be magnetically attached to the main housing 105.

As will be described in more detail below, the provision of a removable cap 106 and in particular that the cap may include a receptacle 120 for receiving the consumable, which may be located, in use, in close proximity to a heating element 104 may cause heat energy to be transferred into the removable cap 106 which is undesirable.

Accordingly, embodiments are disclosed which are concerned with diverting heat energy away from the removable cap 106.

As shown in FIG. 2, the removable cap 106 includes a receptacle 120 for receiving a consumable. In use, an aerosol generating article is inserted in the receptacle 120. The removable cap 106 also includes a second outer casing 109. The second outer casing 109 is arranged to fit at least partially over the main housing 105. In use, the main housing 105 is partly received between the second outer casing and the receptacle 120. The receptacle 120 and the second outer casing 109 may be a one piece component. In other embodiments, the receptacle 120 and the second outer casing 109 may be separate components which are permanently joined together, for example by an adhesive or by welding. In other embodiments, the receptacle 120 and the second outer casing 109 may be separable.

The receptacle 120 comprises a tubular housing having a base portion 121. The base portion 121 of the receptacle 120 has an aperture and the resistive heating element 104 is arranged to project through the aperture.

An aerosol generating article may be inserted into the aerosol provision device 100 by inserting the aerosol generating article through an opening in the removable cap 106 and then inserting the aerosol generating article into the receptacle 120 and onto the heating element 104.

The heating element 104 may have a blade like profile and in use an aerosol generating article may be forced onto the heating element 104 so that the blade like profile of the heating element 120 inserts into a distal end of the aerosol generating article. The heating element 104 is arranged to internally heat the aerosol generating article.

At the end of a session of use, when an aerosol generating article has been consumed, the removable cap 106 may then be detached from the main housing 105. It will be understood that the process of detaching the removable cap 106 will have the effect that the base portion 121 of the receptacle 120 will contact a bottom face of the aerosol generating article. As the removable cap 106 is withdrawn, then the base portion 121 of the receptacle 120 will contact the distal end of the aerosol generating article and will result in the aerosol generating article being pulled off or otherwise removed from the heating element 104.

It will be understood, therefore, that the provision of a removable cap 106 including a receptacle 120 is beneficial. However, since the receptacle 120 is located in close proximity to the heating element 104 then heat energy may be transferred into the receptacle 120 and then into the second outer casing 109 of the removable cap 106 which may be touched by a user.

In order to divert heat energy away from the receptacle 120 and second outer casing 109, the aerosol provision device 100 may comprise a graphite liner which is intended, instead, to divert heat energy into a casing which surrounds the main body of the aerosol provision device 100 rather than the removable cap 106.

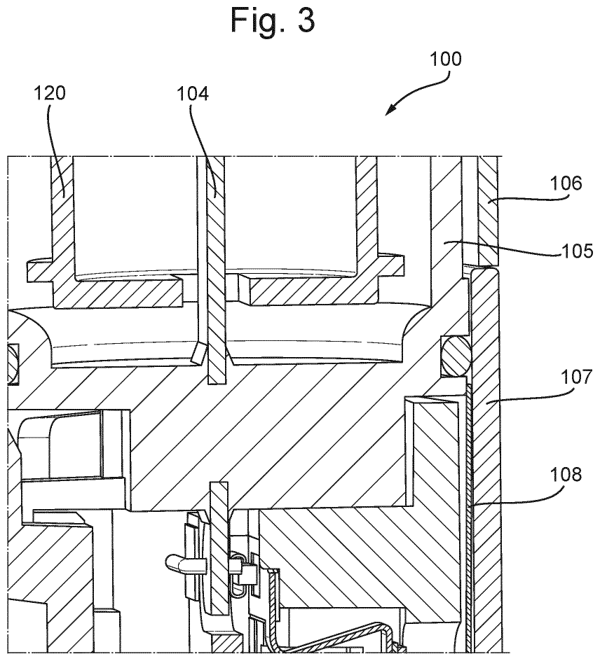

FIG. 3 shows a cross-sectional view of the aerosol provision device 100 according to an embodiment. The aerosol provision device 100 comprises a main housing 105 wherein a heating element 104 is shown extending from the main housing 105. The main housing 105 surrounding the heating element 104 may have a substantially tubular form. The heating element 104 may be arranged to project through an aperture provided in the base portion of the receptacle 120.

It will be understood that the main housing 105 in the vicinity of the heating element 104 and the receptacle 120 will become hot in use due to the heating element 104 becoming warm. Some of the heat generated by the heating element 104 may potentially be transmitted to the second outer casing 109 via the receptacle 120.

It will be understood that it is undesirable for the removable cap 106 to become too hot and exceed a safe temperature. Furthermore, it will be understood that if the removable cap 106 were to become too hot then this would raise potential safety issues. In order to mitigate against such issues the aerosol provision device further comprises a graphite liner 108 which is arranged to be in both physical and thermal contact with the main housing 105 and also with a first outer casing 107 which surrounds the main body of the aerosol provision device 100. The first outer casing 107 may comprise a metal. In particular, the first outer casing 107 may comprise aluminum.

According to various embodiments the first outer casing 107 surrounds at least a portion of the main housing 107. The graphite liner 108 is arranged so as to be in thermal contact both with a portion of the main housing 105 which is in close proximity to the heating element 104 and also with the first outer casing 107 in order to conduct heat energy away from the main housing 105 and into the first outer casing 107. If the graphite liner 108 were not provided then excess heat energy might otherwise be transmitted via the receptacle 120 into the second outer casing 109. As a result, the second outer casing 109 might become hot which is undesirable.

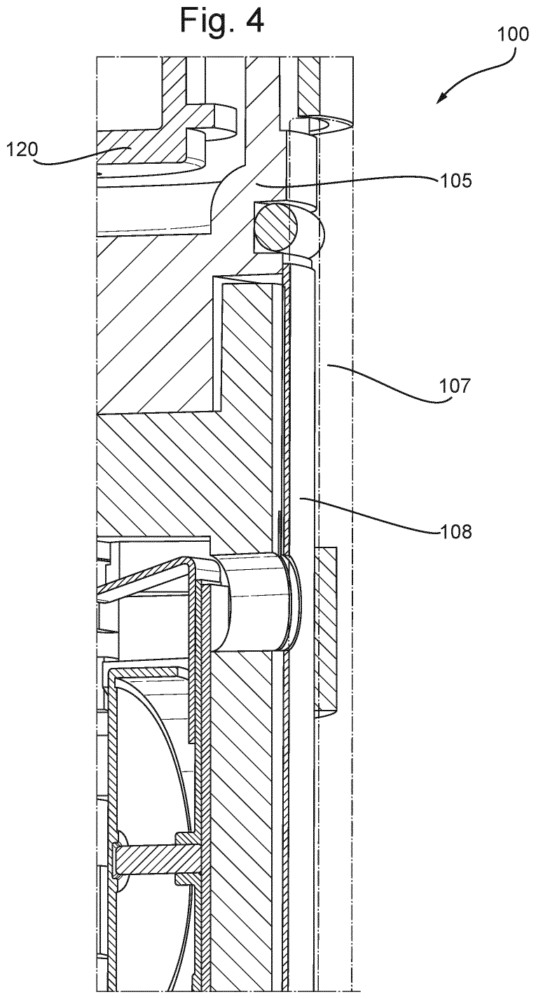

FIG. 4 shows in more detail how the graphite liner 108 may be arranged so as to be in thermal contact both with a portion of the main housing 105 adjacent the heating element and also with a metallic outer casing 107 which surrounds at least a portion of the main housing 105. The metallic outer casing 107 may comprise aluminum.

According to various embodiments the graphite liner 108 may be curved or annular shaped following the profile of the inside of the outer casing 107. According to various embodiments the graphite liner 108 may extend a portion or the whole circumferential distance around the aerosol provision device 100. For example, the graphite liner 108 may have a C-shaped or circular cross-sectional profile. The graphite liner 108 may be tubular in form or may comprise a truncated tubular element.

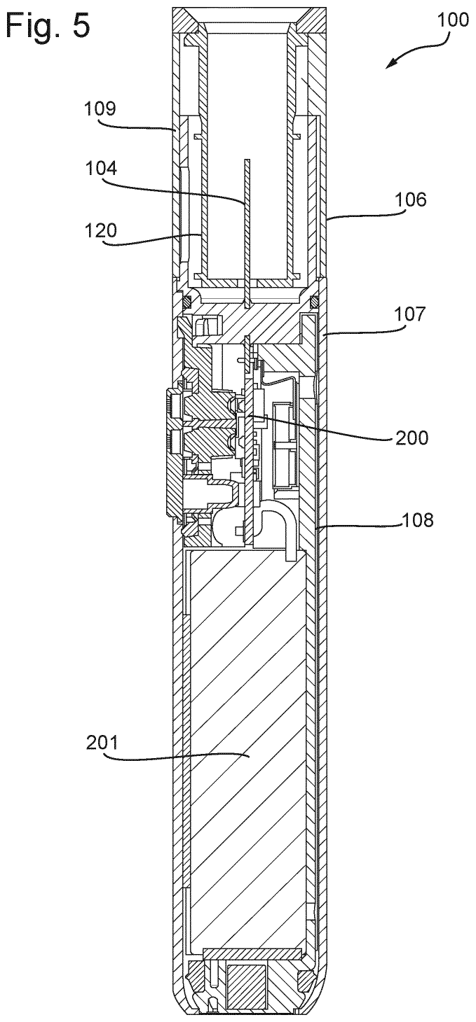

FIG. 5 shows a cross-sectional view of the whole of an aerosol provision device 100 according to an embodiment and shows that the graphite liner 108 may extend at least 50% of the longitudinal length of the aerosol provision device 100 (i.e. main housing and removable cap 106).

According to various embodiments the graphite liner 108 may contact the outer housing or casing 107 of the aerosol provision device 100 throughout an intermediate and a distal portion of the aerosol provision device 100. For example, the graphite liner 108 may contact the outer casing 107 in an intermediate region which may include an electronics module which may include a printed circuit board (“PCB”) 200 comprising control electronics which may be connected to the heating element 104.

The graphite liner 108 may also contact the outer casing 107 in a distal region which may include a battery module 201.

According to an embodiment the graphite liner 108 may extend the majority of the length of the aerosol provision device 100 and may contact the metallic outer casing 107 in a region adjacent the electronics module including the printed circuit board 200 and also in a region adjacent the battery module 201.

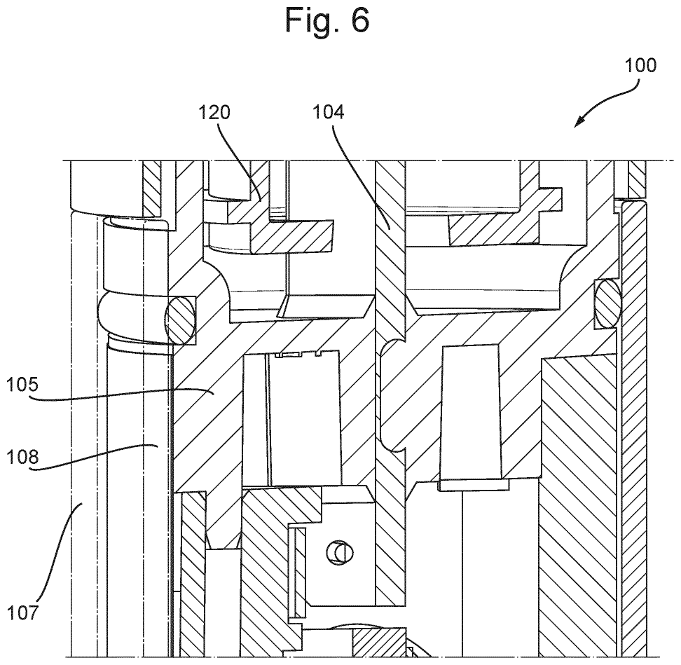

FIG. 6 shows another view showing the location of the graphite liner 108 according to an embodiment. The graphite liner 108 is shown as being in thermal contact with a portion of the main housing 105 and also with the metallic outer casing 107 which surrounds at least a portion of the main housing 105.

According to various embodiments an aerosol provision device 100 is disclosed having a heating element 104. A receptacle 120 for receiving a consumable may surround the heating element 104 and the receptacle 120 may be part of a removable cap 106 which may be magnetically retained to the main housing 105 of the aerosol provision device 100.

It will be understood that there may be a tendency for heat energy to be transferred from the heating element 104 into the removable cap 106 via the receptacle 120 unless mitigation is made.

According to various embodiments a graphite liner 108 is provided which makes physical and thermal contact with the main housing 105 in proximity to the heating element 104. The graphite liner 108 is arranged to divert heat energy away from the receptacle 120 and hence the removable cap 106 and instead to dissipate the heat energy into an outer casing 107 which surrounds an electronics module and also a battery module 201 which are both provided in the main body of the aerosol provision device. It will be understood that the graphite liner 108 may have a relatively large surface area. According to various embodiments the graphite liner 108 may have a surface area <5 cm², 5-10 cm², 10-15 cm², 15-20 cm², 20-25 cm², 25-30 cm², 30-35 cm², 35-40 cm², 40-45 cm², 45-50 cm² or >50 cm².

Although reference has been made above to a graphite liner 108, other embodiments are contemplated wherein the liner may more generally comprise a carbon-based material. For example, embodiments are contemplated wherein the graphite liner 108 may be substituted with a liner comprising graphene or carbon nanotubes. Further embodiments are also contemplated wherein a graphite liner 108 may be provided and a second liner fabricated from a different material may be arranged in thermal contact with the graphite liner 108. For example, the second liner may be made from graphene or carbon nanotubes.

It will be apparent, therefore, that an aerosol provision device 100 including a graphite liner 108 as detailed above is particularly beneficial particularly when the aerosol provision device 100 includes a removable cap 106 and it is desired to maintain the removable cap 106 at a relatively cool or low temperature.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device comprising:
a main housing having a base portion;
a heating element which projects from the base portion of the main housing;
a first outer casing surrounding at least a portion of the main housing; and
a graphite liner, wherein the graphite liner is arranged so as to be in thermal contact with the base portion of the main housing and also with the first outer casing in order to conduct heat energy away from the base portion to the first outer casing.

2. An aerosol provision device as claimed in claim 1, wherein the base portion of the main housing comprises polyetheretherketone (“PEEK”).

3. An aerosol provision device as claimed in claim 1, wherein the first outer casing comprises a first metal.

4. An aerosol provision device as claimed in claim 3, wherein the first metal comprises aluminum.

5. An aerosol provision device as claimed in claim 1, wherein the heating element comprises a resistive heating element.

6. An aerosol provision device as claimed in claim 1, wherein the main housing further comprises a tubular element.

7. An aerosol provision device as claimed in claim 1, further comprising a removable cap which in use is retained to the tubular element.

8. An aerosol provision device as claimed in claim 7, wherein the removable cap comprises a receptacle for receiving an aerosol generating article which at least partially surrounds the heating element.

9. An aerosol provision device as claimed in claim 8, wherein the receptacle comprises polyetheretherketone (“PEEK”).

10. An aerosol provision device as claimed in claim 8, wherein the receptacle comprises a tubular portion and a base portion, and wherein the base portion of the receptacle comprises an aperture.

11. An aerosol provision device as claimed in claim 10, wherein the heating element projects, in use, through the aperture provided in the base portion of receptacle.

12. An aerosol provision device as claimed in claim 7, wherein the removable cap further comprises a second outer casing.

13. An aerosol provision device as claimed in claim 12, wherein the second outer casing surrounds, in use, the tubular element of the main housing.

14. An aerosol provision device as claimed in claim 12, wherein the second outer casing comprises a second metal.

15. An aerosol provision device as claimed in claim 14, wherein the second metal comprises aluminum.

16. An aerosol generating system comprising:
an aerosol provision device as claimed in claim 1; and
an aerosol generating article.

17. A method of generating an aerosol comprising:
providing an aerosol provision device as claimed in claim 1; and
inserting an aerosol generating article into the aerosol provision device.

18. An aerosol provision device comprising:
a main housing having a base portion;
a heating element joined to the main housing;
a first outer casing surrounding at least a portion of the main housing; and
a graphite liner, wherein the graphite liner is arranged so as to be in thermal contact with the base portion of the main housing and also with the first outer casing in order to conduct heat energy away from the base portion to the first outer casing.
